(19) United States
(12) Patent Application Publication
(10) Pub. No.: US 2011/0239826 A1
(43) Pub. Date: Oct. 6, 2011

(54) Lubrication wrench

(76) Inventor: Rinaldo Swayne, Carson, CA (US)

(21) Appl. No.: 12/798,432

(22) Filed: Apr. 5, 2010

(51) Int. Cl. B25B 23/16; B25B 13/58

(52) U.S. Cl. 81/2; 81/185.1

(57) ABSTRACT

A wrench tool having a wrench head which is removable from a hollow handle. A lubricant dispensing device is secured within the handle and a tube delivers lubricant to the wrench head.

### BACKGROUND OF THE INVENTION

1. Field of the Invention

The present invention provides a bolt removal tool having a removable wrench head at one end of tool, the tool handle having a lubricant containing reservoir for supplying lubricant to the wrench head on demand.

2. Description of the Prior Art

The prior art discloses a number of tools that have means for supplying a lubricant, such as oil, to a tool area. For example, U.S. Pat. No. 3,709,549 to Severs discloses lubricating tongs that allow a single workman the capability of handling a workpiece such as a forging while simultaneously lubricating the dies of a press. A pair of tongs 10 with a set of fingers 12, 13 have integral handles 14, 15 that are pivotally connected together at 17. One of the handles, 15, is a hollow member having a plurality of nozzle holes 18 near the end adjacent the fingers 12, 13. The other end of the handle 15 is provided with a hand-operated valve device 20 comprising two valves 28, 29 that are operated by a single hand lever 26 for directing a gas and a liquid through the hollow handle 15. The structure of the valves is such that as hand lever 26 is moved toward the valve housing the first valve 28 is opened and a further movement of the lever opens the second valve 29. The two valves are connected in fluid communication respectively with pressurized sources of a liquid lubricant and a gaseous medium such as air by means of hoses 32, 33. When the workman uses the tongs to insert and remove workpieces he can operate the hand lever 26 as desired to lubricate the dies.

U.S. Pat. No. 5,896,886 to Wendt discloses an oil filter wrench 10 which comprises two wrench halves 11 and 12 which have a slip joint pivotal construction. One of the wrench halves includes and internal oil channel passageway 15 which extends through an interior portion of the wrench handle and through the wrench jaw section into a piercing jaw 20 that is a hardened and sharpened tubular piercing member which extends from the end portion of the serrated jaw. The base of the piercing jaw has an o-ring which seals on an outside surface of an oil filter when the piercing jaw penetrates the oil filter when the wrench is secured around the outside surface of the oil filter. The oil passageway extends to an end portion of the wrench where a nipple 24 is provided for attaching to a tubing 30 which delivers the oil to an oil drip pan for collection.

U.S. Pat. No. 6,523,264 to Albert et al discloses a method and apparatus for cutting sheet material while simultaneously marking the material with a decorative border using a pumping apparatus with a pressure pump 27, first air conduit 29, air reservoir 31, second air conduit 29a and a coloring means 33. The coloring means 33 has an aperture 36 for dispensing colorant to a cutting surface. In use a person initially operates the pumping apparatus to fill the reservoir completely with air. Once the reservoir is filled an object can be cut and as the cutting proceeds the air pump supplies air to the reservoir and the reservoir supplies air to the coloring means 33.

U.S. Pat. No. 4,783,907 to Ravaux discloses a device for simultaneously cutting and treating a plant stem. The cutting and treating device has two main parts 1 and 2 which are pivotally mounted with respect to each other on a shaft 3. The main part 1 has a cutting blade 9 and a grasping handle 13. Handle 13 has a hollow housing 15 with an opening 17 enabling a capsule 19 to be inserted therein. Part 2 has a blade 84 and a handle 83. The mid portion of parts 1 and 2 are pivotally connected together by a shaft 3 passing therethrough being secure by a nut 6. The capsule 19 contains a viscous treating solution 20 that is supplied to the cutting blades by means of a pumping system that includes nozzle 33, drilling channels 39, pistons 55, 56 and other parts forming a control means that would draw from the store 19 and pump a given amount to the nozzle.

U.S. Pat. No. 1,056,046 to Myers discloses pruning tools having a means to spray over the newly cut surface at each operation a quantity of disinfecting liquid. Clippers have cutting blades A, B that are pivoted together and connected to handles. The handle or jaw A is made in two parts with part E containing a reservoir for the disinfectant. A tube F¹ connects the reservoir to a small union I. A rubber atomizer bulb G is located between the handles and acts as an air pump. A tube F³ is connected from the junction to one jaw and a tube F² is connected from the junction to jaw B. The tubes F¹, F², F³ are located in grooves or channels in the face of the members A. When the clippers are operated the disinfectant will be automatically sprayed onto the jaws and sterilize the clipped area.

Although the above noted references disclose various tools that have mechanisms for delivering lubricant to a selected tool area, what is desired is to have a wrench tool that enables simple replacement of different sized wrench heads while leaving the lubricant delivery mechanism in place.

### SUMMARY OF THE INVENTION

The present invention provides a lubricating tool having an open ended wrench design at one end that can be used in any application that requires removal of machine bolts. The tool of the present invention has two modes of operation; in the first, the tool can be used as a conventional open ended wrench when removing threaded bolts or nuts that are attached to the bolt; in the second mode the tool is used to lubricate rusted or new bolts and nuts while removing or fastening the bolt or nut. The removable wrench design enables a wide variety of wrench sizes to be utilized.

### DESCRIPTION OF THE DRAWINGS

For a better understanding of the present invention as well as other objects and further features thereof, reference is made to the following description which is to be read in conjunction with the accompanying drawing therein:

FIG. 1 illustrates a front view of the tool of the present invention;

FIG. 2 is a side view of the tool shown in FIG. 1;

FIG. 3 is a cross-sectional view along line 3-3 of FIG. 2;

FIG. 4 is a cross-sectional view along line 4-4 of FIG. 3;

FIG. 5 is a cross-sectional view along line 5-5 of FIG. 3;

FIG. 6 is a cross-sectional view along line 6-6 of FIG. 3;

FIG. 7 is a cross-sectional view along line 7-7 of FIG. 3; and

FIG. 8 is a cross-sectional view along line 8-8 of FIG. 3.

### DESCRIPTION OF THE INVENTION

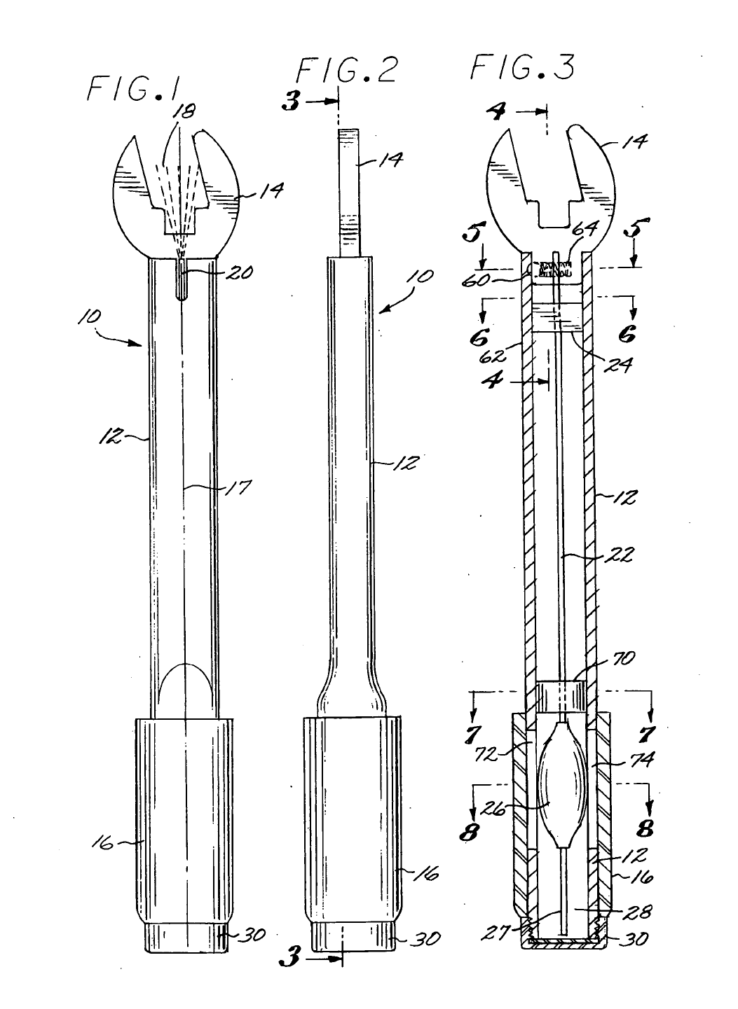

FIG. 1 illustrates tool 10 of the present invention in a front view and FIG. 2 is a side view of tool 10. Tool 10 comprises handle 12 and removable wrench head 14 and reservoir 16 and has a vertical axis 17. FIG. 1 illustrates a spray of lubricant 18 being emitted from nozzle 20.

FIG. 3 is a cross-sectional view along line 3-3 of FIG. 2. A hollow steel tube 22 is positioned within handle 12 as illustrated and as held in position by retainer 24. Handle 12 contains reservoir 26 and feed tube 27 such as a rubber bulb, that is attached to steel tube 22. Hollow chamber 28 is filled with a lubricant, such as oil, chamber 28 being sealed by removable cap 30.

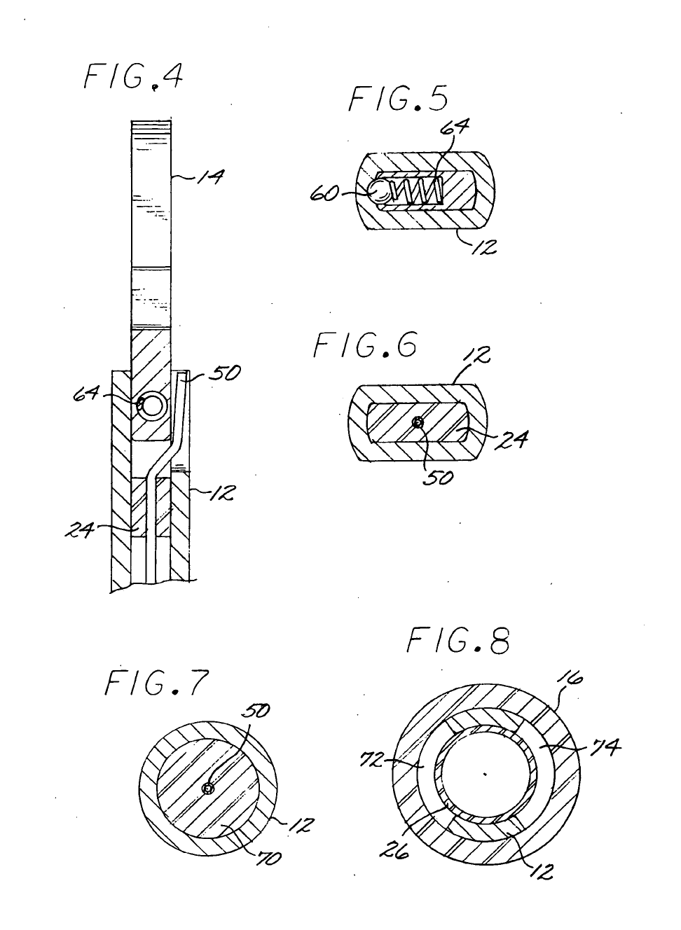

FIG. 4 is a cross-sectional view along line 4-4 of FIG. 3 and shows lubricant tube 22 extending vertically in the center of handle 12, portion 51 bent at an angle to the vertical axis 17 and a portion 52 also bent at an angle to the vertical axis positioned in slot, or cutout portion, 54 formed in the side of handle 12. Angled portions 51 and 52 enable wrench heads of different thickness and sizes/shapes to be utilized with a single lubricant containing handle.

FIG. 5 is a cross-sectional view along line 5-5 of FIG. 3 and illustrates how ball bearing 60 holds wrench head 14 in place. In particular, when a wrench head 14 is inserted into handle 12, the bearing 60 is forced into an indentation formed into wall 62 of handle 12, spring 64 forcing bearing 60 into the protrusion thus locking wrench head 14 in place.

FIG. 6 is a cross-sectional view along line 6-6 of FIG. 3 illustrating retainer 24 holding lubricant tube 50 in place.

FIG. 7 is a cross-sectional view along line 7-7 of FIG. 3 showing the top seal 70 of lubricant reservoir 28.

FIG. 8 is a cross-sectional view along line 8-8 of FIG. 3 illustrating handle 12 has cutouts 72 and 74 enabling pressure bulb 26 to be operable.

In summary, the wrench 10 provides a tool that aids in the removal of rusted and difficult to remove bolts. Conventional lubricants have difficulty in addressing bolts in awkward positions or places with limited access. The tool allows a user to easily apply a lubricant to the rusted bolt. Once the nut starts to loosen, the lubricant will begin to penetrate the bolt and nut, allowing for easier removal. The user can continuously apply the lubricant while rotating the bolt or nut.

Tool 10 has a common open ended wrench head 14 on one end and a handle 12 on the opposite end. Wrench head 14 is removable and is locked in place by the tension provided by spring 64 forcing ball bearing 60 into the adjacent recess. Handle 12 has a reservoir 28 that contains the lubricant. A threaded cap 30 with a rubber seal at the end of handle 12 can be removed to fill reservoir 28 with lubricant. Rubber bulb 26 is built into the handle 12 and is attached to internal hollow steel feeding tube 30. When bulb 26 is repeatedly squeezed, the lubricant, by pressure, travels through the tube 30 up to the nozzle discharge area. The nozzle discharge is preferably slightly angled outwards to direct the lubricant to the screw area and not the outside of the nut. Wrench head 14 is removed from handle 12 by the user pulling wrench head 14 outwardly and overcoming the tension force of spring 64.

Since wrench head 14 is removable, it can be replaced by different sized wrench heads as required by the user.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A tool for removing bolts having a vertical axis comprising:
a first sized wrench head removably coupled to a hollow handle;
means for introducing lubricant into said hollow handle;
a tube positioned within said hollow handle and extending towards said wrench head; and
means within said hollow handle for introducing lubricant under pressure to said tube in a manner such that lubricant is emitted adjacent said nozzle head.

2. The tool of claim 1 wherein a first member is secured on the lower portion of said first sized wrench head and wherein a recess is formed on the interior surface of said handle, said first member extending into said recess to removably secure said first sized wrench head to said handle.

3. The tool of claim 2 wherein said first sized wrench head is removed from said handle.

4. The tool of claim 3 wherein a second sized wrench head having a second member secured on its lower portion is coupled to said hollow handle, said second member extending into said recess.

5. The tool of claim 4 wherein said tube is formed of first, second and third portions in sequence, said first portion extending substantially vertically from the bottom of said handle; said second portion being bent at an angle to said vertical axis; and said third portion being bent at a angle to said vertical axis.
